(19) United States
(12) Patent Application Publication
(10) Pub. No.: US 2005/0200595 A1
(43) Pub. Date: Sep. 15, 2005

(54) Input device for an information system

(76) Inventors: Steven Lawrence Fors, Chicago, IL (US); Mark M. Morita, Arlington Heights, IL (US); Khal A. Rai, Round Lake, IL (US)

Correspondence Address: MCANDREWS HELD & MALLOY, LTD, 500 WEST MADISON STREET, SUITE 3400, CHICAGO, IL, 60661, US

(21) Appl. No.: 10/800,108

(22) Filed: Mar. 12, 2004

(51) Int. Cl. G09G 5/00

(52) U.S. Cl. 345/156

(57) ABSTRACT

Embodiments of the present invention provide an input device is configured for use with a processing unit in communication with the input device and a touch-sensitive monitor. The input device includes a main body having a distal operative end, and a rollerball positioned within a bearing at the distal operative end. The bearing retains the rollerball so that the rollerball is capable of rolling within the bearing. Movement of the rollerball is detectable by the processing unit so that digital data is input into the monitor through the rollerball.

### BACKGROUND OF THE INVENTION

Embodiments of the present invention generally relate to information systems, and more particularly to an improved input device for an information system, such as a scheduling system within a medical environment.

Typical computers include a processing unit operatively connected to a monitor and one or more input devices. The input devices may be a keyboard, mouse, and the like. Some systems, such as electronic day planners, include a stylus that allows a user to input information directly therein. The electronic day planners typically include a small screen over which the stylus interacts. However, if a user presses too hard on the stylus, the point of the stylus may damage the screen. Also, the stylus tends to slide over the screen. The sliding friction caused thereby may physically wear the screen after repeated use.

Also, many computer systems include touch sensitive monitors that allow a user to input digital information through a touchscreen monitor. The touchscreen couples to a processor to provide control over the system. The touchscreen may be implemented as a resistive, capacitive, or other touchscreen that provides an indication to the processor that an operator has touched the touchscreen and a location of the touch. The touchscreen is typically positioned in front of a monitor that presents an image display of graphics and text associated with operation of the system.

In various settings, such as medical environments, touch sensitive systems are used. However, the use of touch sensitive computer systems typically leads to bacterial cross-contamination. That is, a first user touches a touch sensitive monitor and bacteria, germs and the like are transferred from the first user's finger to the monitor. The bacteria may then be transferred from the screen to a second user, who may be operating on a patient.

Hospitals, clinics, and the like also utilize white boards in order to display logistical information, such as procedural scheduling. Typically, the white boards include large writing areas. Hospital staff manually write information on the white boards with standard pens, markers, and the like. Alternatively, some white boards may include a light box positioned over a screen. Hospital staff may then write on transparencies and position them over the light box. However, if changes need to be made to information on the white boards, the information is not automatically transmitted back to a hospital server. Instead, a staff member must input the information to the server by way of a networked computer. Typically, the staff member types in the information to the computer by way of the keyboard and then commands the computer to send the information to the central database.

Thus, a need exists for an improved input device that is configured to be used in computer applications. Additionally, a need exists for an efficient system and method of inputting digital information in a medical environment that minimizes the risks of cross-contamination.

### SUMMARY OF THE INVENTION

Embodiments of the present invention provide an input device configured for use with a processing unit in communication with the input device and a touch-sensitive monitor. The input device includes a shaft-like main body, which may be pen-shaped, having a distal operative end, wherein the shaft-like main body is formed of an anti-bacterial plastic. An anti-bacterial rollerball assembly is located at the distal operative end of the main body. The rollerball assembly includes a rollerball retained within a bearing. The rollerball assembly is configured to electrically communicate with the processing unit. The bearing retains the rollerball so that the rollerball is capable of rolling within the bearing. Movement of the rollerball is detectable by the processing unit so that a user may input digital data onto the monitor through the rollerball assembly.

A plurality of anti-bacterial lateral buttons may also be positioned on the main body. The plurality of lateral buttons are configured to electrically communicate with the processing unit. The plurality of lateral buttons may be color-coded to denote different functionality.

The rollerball is configured to click when the input device is pressed against a surface. The click of the rollerball is detectable by the processing unit.

Embodiments of the present invention also provide a medical information system including a workstation having a processing unit, an electronic white board having a display screen in communication with the workstation, and the input device described above. The white board may display patient scheduling information on the display screen. The input device is configured to directly contact the display screen in order to input and manipulate data displayed on the display screen. The input device is configured to click and drag digital data items displayed on the display screen. The input device is also configured to electronically write on the display screen so that the processing unit detects movement of the rollerball and displays corresponding information on the display screen. Additionally, the input device may be used as a pointer for touching the screen. That is, the input device may be used with a touch sensitive monitor in place of a user's finger.

Embodiments of the present invention also provide a method of inputting data into a processing unit of a computer, wherein the processing unit displays the data on a screen of a monitor in communication with the processing unit. The method includes providing a rollerball at a distal end of an input device, electrically connecting the input device with the processing unit so that the processing unit detects movement of the rollerball, contacting the screen with the input device so that the rollerball is in direct contact with the screen, detecting movement of the rollerball by the processing unit, and displaying data on the screen that corresponds to said detecting step when the input device is activated for data input.

The method also includes activating the input device for data input by pressing the input device into the screen until the rollerball clicks. The activating may include single clicking the rollerball in order to activate a click and drag function, or double clicking the rollerball in order to activate an electronic writing function.

### BRIEF DESCRIPTION OF SEVERAL VIEWS OF THE DRAWINGS

FIG. 1 illustrates a simplified representation of a medical information system according to an embodiment of the present invention.

FIG. 2 illustrates an isometric view of an input device according to an embodiment of the present invention.

FIG. 3 illustrates a flow chart of a click and drag function according to an embodiment of the present invention.

FIG. 4 illustrates a flow chart of a writing function according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

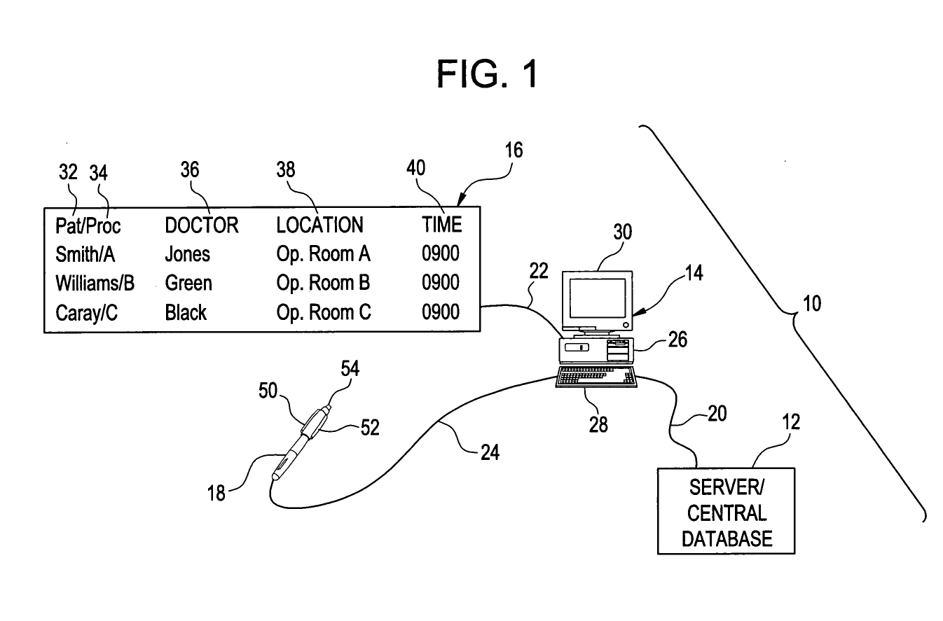

FIG. 1 illustrates a simplified representation of a medical information system 10 according to an embodiment of the present invention. The system 10 includes a server or central database 12, a workstation 14, a digital white board 16, and an input device 18. The central database 12 is in communication with the workstation 14 through wiring 20, while the workstation 14 is in communication with the white board 16, by way of wiring 22, and the input device 18, by way of wiring 24. Optionally, the components of the system 10 may be in wireless communication with one another.

The workstation 14 includes a central processing unit (CPU) 26 in communication with at least one input device 28 (such as a keyboard, mouse, and the like), and a monitor 30. The input device 18, the white board 16, and the central database 12 are all in communication with the CPU 26.

The central database 12 centralizes various forms of data, such as scheduling information for various procedures within a medical environment, such as a hospital, catherization laboratory, imaging laboratory, and the like. The scheduling information may be input into the central database 12 through the workstation 14, and/or a separate computer system located proximate the central database 12.

Scheduling information for a particular medical location is displayed on the white board 16. The white board 16 may be a large display monitor, such as a plasma screen, that is electrically connected to the workstation 14. The central processing unit 26 of the workstation 14 is operable to display the scheduling information that is received from the central database 12, or generated at the workstation 14, on the white board 16.

As shown in FIG. 1, the white board 16 may display scheduling information including patient name 32 and a procedure 34 to be performed, the doctor, physician, or technician 36 that is to perform the procedure, the location 38 of the procedure and the time 40 of the procedure. Scheduling information input at the workstation 14 is transmitted to the central database 12 and shown on the white board 16.

As mentioned above, the scheduling information may be input through the input device 28 of the workstation 14, or at the central database 12. Additionally, scheduling information may also be input, modified, and the like, through the input device 18 interacting with the white board 16. Additionally, scheduling information may be input on the workstation 14 through the input device 18.

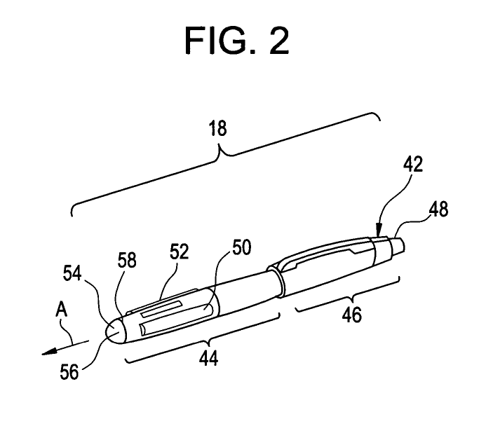

FIG. 2 illustrates an isometric view of the input device 18. The input device 18 may be a pen or stylus shaped structure having a main body 42. The main body 42 is formed of an anti-bacterial plastic, or another anti-bacterial material, such as disclosed, for example, in United States Patent Application Publication 2003/0170453, entitled “Anti-Microbial Fiber and Fibrous Products,” or various other known types of anti-bacterial material. The main body 42 includes an operative shaft 44 integrally formed with a support member 46. Wiring (as shown in FIG. 1) or a wireless communication transmitter/receiver extends from a terminal end 48 of the support member 46.

The operative shaft 44 includes lateral buttons 50 and 52 and a rollerball 54 positioned at a distal tip 56 of the main body 42. The lateral buttons 50 and 52 are positioned on the outer lateral surfaces of the operative shaft 44. The lateral buttons 50 and 52 may be similar to the right and left buttons on a mouse, or may alternatively be various other types of buttons, membrane switches, toggle switches, slide switches and the like.

The rollerball 54 is securely retained by a bearing 58 that allows the rollerball 54 to roll therein, similar to a ball point pen. The rollerball 54 and lateral buttons 50 and 52 are electrically connected to internal circuitry and wiring (not shown) within the main body 42 that is, in turn, electrically connected to the wiring 24 (as shown in FIG. 1) or a wireless communication transmitter/receiver that is in communication with the workstation 14 (shown in FIG. 1). The lateral buttons 50 and 52 may be color coded to denote particular applications. For example, the lateral button 50 may be red, which may indicate a “right-click” mouse button function, while the lateral button 52 may be green, which may indicate a “left-click” mouse button function. A “right click” function may prompt an options menu to appear on a screen. The options menu may provide various functional choices to a user, such as “cut,” “copy,” “paste,” and the like. A “left click” function may operate to locate a cursor on the screen such that text may be input from that point.

Optionally, more or less buttons may be positioned on the input device 18. For example, an additional button may be positioned on the operative shaft that functions as a “double click.” A “double click” may open a file or application.

The input device 18 may be used to input data by touching a touch-sensitive screen of a monitor with the input device 18. That is, instead of using a finger to touch the screen, a user may use the input device 18 to contact the screen. Additionally, as discussed below, the input device 18 offers mouse-like functionality.

The rollerball 54 is adapted for, among other things, “click and drag” applications. The rollerball 54 is configured to be in communication with a central processing unit, which includes hardware and/or software that is configured to correlate movement of the rollerball 54 over a corresponding computer monitor screen with actions to be displayed on the screen.

For example, the rollerball 54 may be positioned over an item on a computer screen. A user may then push down on the input device 18 in the direction of the screen in order to click the rollerball 54. The rollerball 54 may be spring biased within the input device so that it may move in longitudinal directions relative to the main body of the input device 18 when the rollerball 54 is pressed into, and subsequently moved away from, a surface. Additionally, the rollerball 54 may be proximate a clicker device (not shown) such that when the rollerball contacts the clicker device, the clicker device produces a clicking sound and corresponding movement. The movement of the clicker generates a click signal that is then relayed to the CPU 26. The clicking of the rollerball 54 sends a signal to a processing unit to command the item to be “dragged” on the display in relation to movement of the input device 18. The input device 18 may then be moved over the screen in order to drag the item to another location on the screen. The ability of the rollerball 54 to roll over the screen provides a reduced friction method of moving the input device 18 over the screen. Additionally, because the rollerball 54 rolls over the screen, the chance that the screen will be gouged, scratched, or otherwise damaged is reduced and/or minimized.

Additionally, the input device 18 is configured to digitally input information directly onto a computer screen, similar to a stylus inputting information onto a device such as an electronic day planner, palm pilot, or the like. That is, a user may electronically write on the screen with the input device 18. In particular, the input device 18 may include a button that activates a writing function. Optionally, the input device 18 may be configured so that a double click of the rollerball 54 in the direction of A activates a writing function. Once the writing function is enabled, a user may electronically write on a suitable screen of a monitor that is electronically connected to a processing unit having appropriate software and hardware.

Referring now to FIGS. 1 and 2, the input device 18 may change information on the white board 16 by way of a user contacting the white board 16 with the input device 18 and activating the input device 18 accordingly. The input device 18 may be used to click and drag an item, such as patient name 32 to a different location. For example, the input device 18 may be pushed toward the white board 16 over a patient name 32 until the rollerball 54 clicks. Once the rollerball clicks 54, a signal is sent from the input device 18 to the central processing unit 26, which then activates a drag function. The patient name 32 may then be dragged to a different location on the white board 16. When the user is satisfied with the location, the user presses the input device 18 toward the white board 16 until the rollerball 54 clicks. When the rollerball 54 clicks, a signal is sent to the CPU 26 to position the patient name 32 icon on the white board 16 at a position proximate the rollerball 54. The CPU 26 then transmits the modified information back to the central database 12.

Additionally, the input device 18 may be activated to electronically write on the white board 16. For example, the input device 18 may be used to electronically write words, such as a patient's name, doctor, and the like directly on the white board 16. As discussed above, the input device 18 may include a separate button in order to activate the writing function. Optionally, the input device 18 may be twice depressed to double click the rollerball 54, which then transmits a signal to the CPU 26 to initiate a writing function. In order to disable the writing function, the rollerball 54 may be double clicked, or the particular writing button may be depressed again. That is, to initiate the function, the input device 18 includes a button or member, such as the rollerball 54, that may be double clicked. In order to disable the writing function, the button or member is double clicked again.

The lateral buttons 50 and 52 may also be used with respect to the white board 16. The lateral buttons 50 and 52 may be used to activate certain functions, as discussed above with respect to FIG. 2.

The use of the input device 18 with the system 10 minimizes or prevents direct touching of the white board 18, monitor 30, and the like. Thus, cross-contamination between these components and other structures within a medical environment is also minimized. Further, as discussed above, the main body 42 of the input device 18 is formed of an anti-bacterial material. That is, the outer structure of the input device 18, including the rollerball 54 and the lateral buttons 50, 52 are all formed of an antibacterial material, or covered with an anti-bacterial coating. Thus, bacteria from a user that is transferred to the input device is destroyed and/or neutralized upon contact.

While the input device 18 may be used with the white board 16, the input device 18 may also be used to input, modify and manipulate information on the monitor 30. That is, the input device 18 may be used in lieu of a mouse with any standard computer having software/hardware that is compatible with touch sensitive monitors and the input device 18.

The input device 18 is capable of performing all the functions of a mouse, with the additional functionality provided by the rollerball 54. The rollerball 54 allows a user to quickly and easily traverse distances over a large screen, such as the white board 16, due to the ability of the rollerball 54 to roll or glide over the surface of the white board 16.

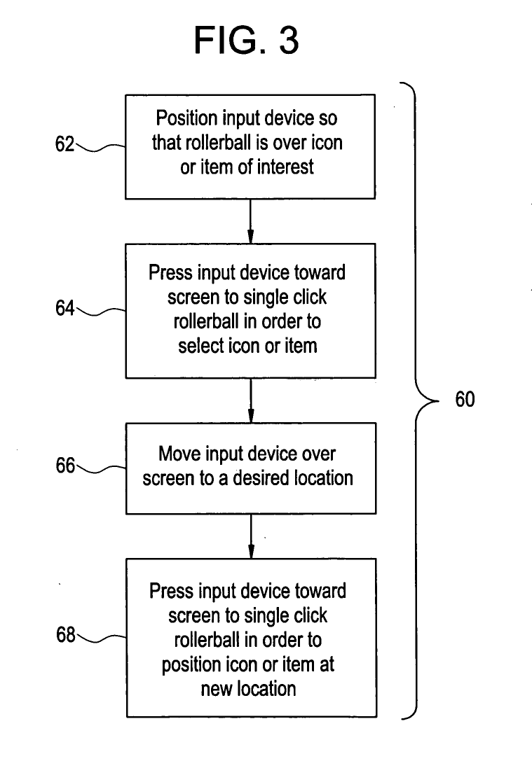

FIG. 3 illustrates a flow chart 60 of a click and drag function according to an embodiment of the present invention. At 62, a user positions the input device 18 so that the rollerball 54 is located over an icon or item of interest on a screen (such as the white board 16). The user then presses the input device 18 toward the screen to single click the rollerball 54 in order to select the icon or item of interest at 64. The single click of the rollerball 54 sends a signal to a central processing unit to activate the click and drag function. At 66, the user moves the input device 18 over the screen to a desired location. The icon or item of interest is dragged over the screen through positions corresponding to the position of the input device 18. At 68, a user presses the input device 18 toward the screen to single click the rollerball 54 in order to position the icon or item at a location on the screen that is proximate the input device 18. Optionally, instead of clicking the rollerball 54, the input device 18 may include a separate activation button configured to activate and deactivate the click and drag function.

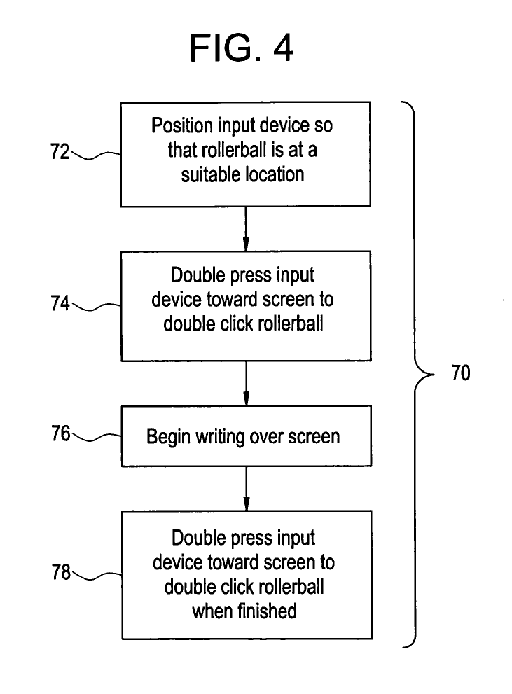

FIG. 4 illustrates a flow chart 70 of a writing function according to an embodiment of the present invention. At 72, a user positions the input device 18 on the screen so that the rollerball 54 is at a suitable location for writing. The user then double presses the input device 18 toward the screen to double click the rollerball 54. The double click sends a signal to the central processing unit to activate the writing function. At 76, the user begins writing with the input device 18 over the screen. The input device rolls or glides over the screen by way of the rollerball 54; hence, the input device 18 does not damage the screen. As the input device 18 glides over the screen, the central processing unit directs a digital trailing line, which corresponds to the path of the input device 18, to be displayed on the screen. When finished electronically writing, the user double presses the input device 18 toward the screen to double click the rollerball 54. The double click of the rollerball 54 sends a signal to the central processing unit to terminate the writing function.

Embodiments of the present invention may be used with various other applications and systems. For example, the input device 18 may be used with a standard personal computer instead of a standard mouse. The input device 18 may be used for everyday computing needs, and is not limited to medical applications.

Thus, embodiments of the present invention provide an improved input device that is configured to be used in various computer applications. Additionally, embodiments of the present invention provide an efficient system and method of inputting digital information in a medical environment that minimizes the risks of cross-contamination.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. An input device configured for use with a processing unit in communication with the input device and a touch-sensitive monitor, the input device comprising:
a main body having a distal operative end; and
a rollerball positioned within a bearing at said distal operative end, said bearing retaining said rollerball so that said rollerball is capable of rolling within said bearing, and wherein movement of said rollerball is detectable by the processing unit.

2. The input device of claim 1, wherein said main body further comprises additional buttons, and wherein pressing of said additional buttons is detectable by the processing unit.

3. The input device of claim 2, wherein said additional buttons are color-coded to denote different functionality.

4. The input device of claim 1, wherein said rollerball is configured to click when the input device is pressed against a surface, and wherein the click of said rollerball is detectable by the processing unit.

5. The input device of claim 1, wherein said main body is shaped like a pen.

6. The input device of claim 1, wherein an outer surface of the input device is formed of an anti-bacterial material.

7. The input device of claim 1, wherein the input device is covered with an antibacterial coating.

8. The input device of claim 1, wherein the input device is configured to wirelessly communicate with the central processing unit.

9. An input device configured for use with a processing unit in communication with the input device and a touch-sensitive monitor, the input device comprising
a shaft-like main body having a distal operative end, wherein said shaft-like main body is formed of an anti-bacterial plastic;
an anti-bacterial rollerball assembly located at said distal operative end of said main body, said rollerball assembly comprising a rollerball retained within a bearing, said rollerball assembly configured to electrically communicate with the processing unit, said bearing retaining said rollerball so that said rollerball is capable of rolling within said bearing, and wherein movement of said rollerball is detectable by the processing unit so that a user may input digital data into the monitor through said rollerball assembly; and
a plurality of anti-bacterial lateral buttons positioned on said main body, wherein said plurality of lateral buttons are configured to electrically communicate with the processing unit.

10. The input device of claim 9, wherein said plurality of lateral buttons are color-coded to denote different functionality.

11. The input device of claim 9, wherein said rollerball is configured to click when the input device is pressed against a surface, and wherein the click of said rollerball is detectable by the processing unit.

12. The input device of claim 9, wherein said main body is shaped like a pen.

13. A medical information system, comprising:
a workstation having a processing unit;
an electronic white board having a display screen in communication with said workstation; and
a pen-shaped input device comprising:
a main body having a distal operative end; and
a rollerball assembly located at said distal operative end of said main body, said rollerball assembly comprising a rollerball retained within a bearing, said rollerball assembly in communicate with said processing unit, said bearing retaining said rollerball so that said rollerball is capable of rolling within said bearing, and wherein said processing unit detects movement of said rollerball.

14. The medical information system of claim 13, wherein said white board displays patient scheduling information on said display screen.

15. The medical information system of claim 13, wherein said input device is configured to directly contact said display screen in order to input and manipulate data displayed on said display screen.

16. The medical information system of claim 15, wherein said input device is configured to click and drag digital data items displayed on said display screen.

17. The medical information system of claim 15, wherein said input device is configured to electronically write on said display screen so that said processing unit detects movement of said rollerball and displays corresponding information on said display screen.

18. The medical information system of claim 13, wherein an outer surface of said input device is formed of an anti-bacterial material.

19. The medical information system of claim 13, further comprising a central database in communication with said workstation.

20. The medical information system of claim 13, wherein said workstation further comprises a monitor having a monitor screen in communication with said processing unit, and wherein said input device is configured to directly contact said monitor screen in order to input and manipulate data displayed on said monitor screen.

21. The medical information system of claim 13, wherein said input device further comprises a plurality of anti-bacterial lateral buttons positioned on said main body, wherein said plurality of lateral buttons are configured to electrically communicate with the processing unit.

22. A method of inputting data into a processing unit of a computer, wherein the processing unit displays the data on a screen of a monitor in communication with the processing unit, comprising:
providing a rollerball at a distal end of an input device;
electrically connecting the input device with the processing unit so that the processing unit detects movement of the rollerball;
contacting the screen with the input device so that the rollerball is in direct contact with the screen;
detecting movement of the rollerball by the processing unit; and
displaying data on the screen that corresponds to said detecting step when the input device is activated for data input.

23. The method of claim 23, further comprising activating the input device for data input by pressing the input device into the screen until the rollerball clicks.

24. The method of claim 22, further comprising single clicking the rollerball in order to activate a click and drag function.

25. The method of claim 23, further comprising double clicking the rollerball in order to activate an electronic writing function.
